(19) United States
(12) Patent Application Publication
(10) Pub. No.: US 2013/0080423 A1
(43) Pub. Date: Mar. 28, 2013

(54) RECOMMENDATIONS FOR SEARCH QUERIES

(71) Applicants: Nishith Parikh, Fremont, CA (US); Neelakantan Sundaresan, Mountain View, CA (US); Gyanit Singh, San Jose, CA (US)

(72) Inventors: Nishith Parikh, Fremont, CA (US); Neelakantan Sundaresan, Mountain View, CA (US); Gyanit Singh, San Jose, CA (US)

(73) Assignee: eBay Inc., San Jose, CA (US)

(21) Appl. No.: 13/624,712

(22) Filed: Sep. 21, 2012

Related U.S. Application Data
(60) Provisional application No. 61/538,403, filed on Sep. 23, 2011.

(51) Int. Cl. G06F 17/30

(52) U.S. Cl. 707/722; 707/E17.005; 707/E17.014

(57) ABSTRACT

A system and method of providing recommendations for search queries are disclosed. A search query is received. Historical data in a historical database is accessed using the search query. The historical data is related to inactive e-commerce items. Recommendations are generated for the search query based on the accessed historical data. The recommendations can comprise item recommendations, category recommendations, and query recommendations. The query recommendations can comprise suggested queries and a preview of search results for each of the suggested queries. The steps of accessing the historical data and generating the one or more recommendations can be performed in response to a determination that the number of results for the search query is below a predetermined threshold.

### RELATED APPLICATIONS

This application claims priority to U.S. Provisional Application No. 61/538,403, filed on Sep. 23, 2011, and entitled, “ITEM RECOMMENDATIONS FOR LOW AND ZERO RESULT QUERIES,” which is hereby incorporated by reference in its entirety as if set forth herein.

### TECHNICAL FIELD

The present application relates generally to the technical field of search query processing, and, in various embodiments, to systems and methods of generating recommendations for search queries.

### BACKGROUND

When trying to find an item on an e-commerce site, users often type a query into the site's search engine, which attempts to match that query against all inventory that is active on the site. Active inventory is currently available, whereas inactive inventory is not available, as it has expired or has already been sold. Although matches for the query are often found and shown to the user, there are also many situations where the site is unable to match the query to any items or only able to match the query to a few items. As a result, a user in such a situation either sees zero inventory from the e-commerce site or very little inventory from that site, despite the fact that items similar or otherwise relevant to those desired by the user might be available. By performing only a simple search engine matching, the site misses out on capitalizing on the user's intent and giving the user a good experience when dealing with these low-result queries.

### BRIEF DESCRIPTION OF THE DRAWINGS

Some embodiments of the present invention are illustrated by way of example and not limitation in the figures of the accompanying drawings, in which like reference numbers indicate similar elements and in which:

FIG. 1 is a block diagram depicting a network architecture of a system, according to some embodiments, having a client-server architecture configured for exchanging data over a network.

FIG. 2 is a block diagram depicting a various components of a network-based publisher, according to some embodiments.

FIG. 3 is a block diagram illustrating an example embodiment of a system that provides recommendations thr low- and zero-result queries.

FIG. 4 illustrates an example embodiment of item recommendations for a search query.

FIG. 5 is a flowchart illustrating an example embodiment of a method for providing recommendations for low- and zero-result queries.

FIG. 6 shows a diagrammatic representation of a machine in the example form of a computer system within which a set of instructions may be executed to cause the machine to perform any one or more of the methodologies discussed herein.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

In order to capitalize on the user's intent and give the user a good experience, information regarding inactive e-commerce items can be used to provide a better active item search, some embodiments of the present invention, a search query is received. Historical data in a historical database in a storage device is then accessed using the search query. The historical data is related to inactive e-commerce items. Recommendations are then generated for the search query based on the accessed historical data. In some embodiments, the recommendations comprise item recommendations. In some embodiments, the search query is modified and a search is performed using the modified search query to generate the item recommendations. In some embodiments, the recommendations comprise category recommendations. In some embodiments, the recommendations comprise query recommendations. In some embodiments, the query recommendations comprise suggested queries and a preview of search results for each of the suggested queries. In some embodiments, the steps of accessing the historical data and generating the recommendations are performed in response to a determination that the number of results for the search query is below a predetermined threshold. In some embodiments, the one or more recommendations comprise multiple forms of recommendations.

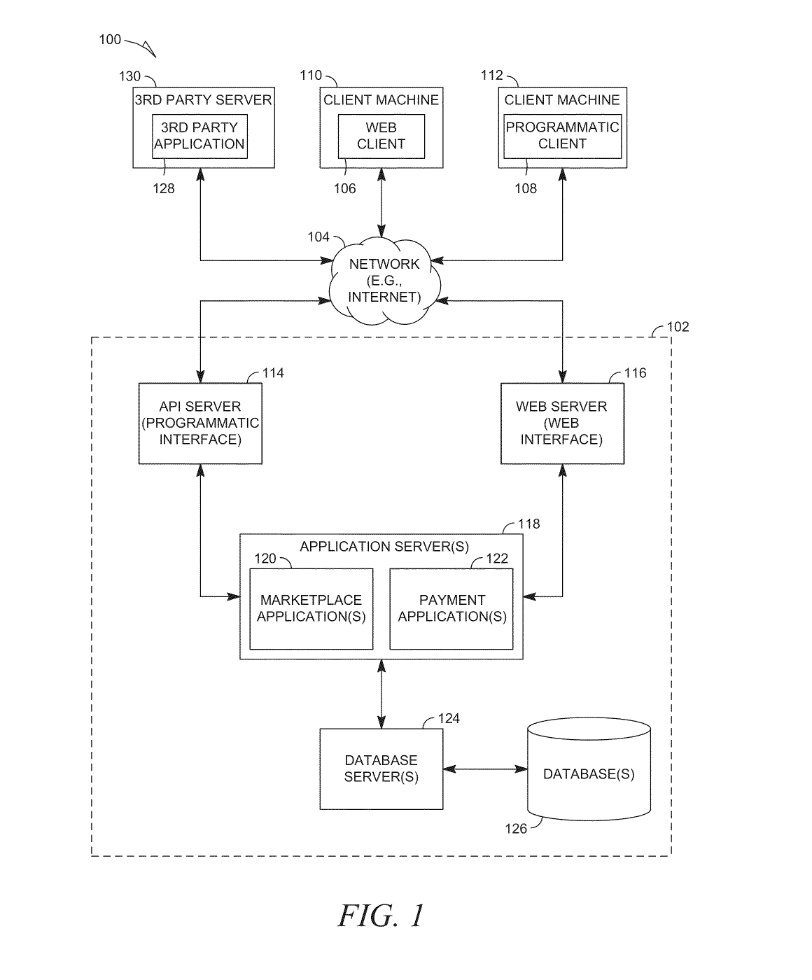

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or a Wide Area Network (WAN)) to one or more clients. FIG. 1 illustrates, for example, a web client 106 (e.g., a browser, such as the Internet Explorer browser developed by Microsoft Corporation of Redmond, Wash. State) and a programmatic client 108 executing on respective client machines 110 and 112.

An API server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more databases servers 124 that facilitate access to one or more databases 126.

The marketplace applications 120 may provide a number of marketplace functions and services to users who access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the embodiments are, of course not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, thr example, provide one or more promotional, marketplace, or payment functions that are supported by the relevant applications of the networked system 102.

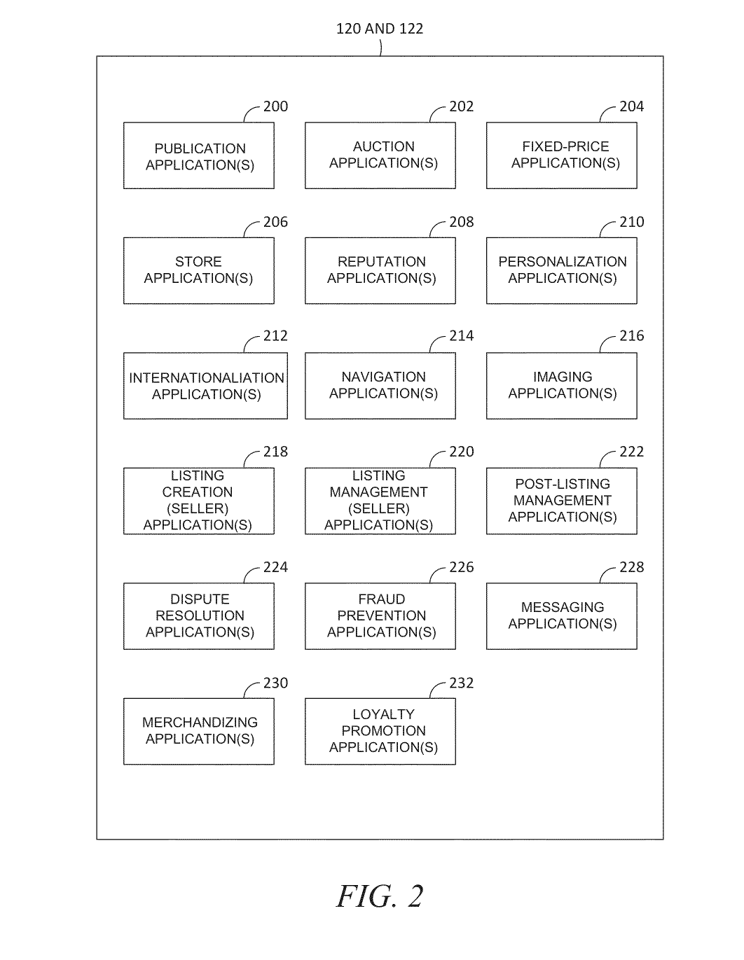

FIG. 2 is a block diagram illustrating multiple applications 120 and 122 that, in one example embodiment, are provided as part of the networked system 102. The applications 120 and 122 may be hosted on dedicated or shared server machines (not shown) that are communicatively coupled to enable communications between server machines. The applications 120 and 122 themselves are communicatively coupled (e.g., via appropriate interfaces) to each other and to various data sources, so as to allow information to be passed between the applications 120 and 122 or so as to allow the applications 120 and 122 to share and access common data. The applications 120 and 122 may furthermore access one or more databases 126 via the database servers 124.

The networked system 102 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace applications 120 and 122 are shown to include at least one publication application 200 and one or more auction applications 202, which support auction-format listing and price setting mechanisms (e.g., English, Dutch, Vickrey, Chinese, Double, Reverse auctions etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives, and features that are specific and personalized to a relevant seller.

Reputation applications 208 allow users who transact, utilizing the networked system 102, to establish, build, and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user (for example, through feedback provided by other transaction partners) to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page at which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace or may be customized (or internationalized) presentations of a common underlying marketplace. The networked system 102 may accordingly include a number of internationalization applications 212 that customize information (and/or the presentation of information) by the networked system 102 according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application 214) may enable key word searches of listings published via the networked system 102. A browse application may allow users to browse various category, catalogue, or inventory data structures according to which listings may be classified within the networked system 102. Various other navigation applications 214 may be provided to supplement the search and browsing applications.

In order to make listings, available via the networked system 102, as visually informing and attractive as possible, the applications 120 and 122 may include one or more imaging applications 216, which users may utilize to upload images for inclusion within listings. An imaging application 216 also operates to incorporate images within viewed listings. The imaging applications 216 may also support one or more promotional features, such as image galleries that are presented to potential buyers. For example, setters may pay an additional fee to have an image included within a gallery of images for promoted items.

Listing creation applications 218 allow sellers to conveniently author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller conveniently to provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102 (such as, for example, messages advising users regarding the status of listings at the networked system 102 (e.g., providing “outbid” notices to bidders during an auction process or to provide promotional and merchandising information to users). Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotions applications 232. For example, a buyer may earn loyalty or promotion points for each transaction established and/or concluded with a particular seller, and be offered a reward for which accumulated loyalty points can be redeemed.

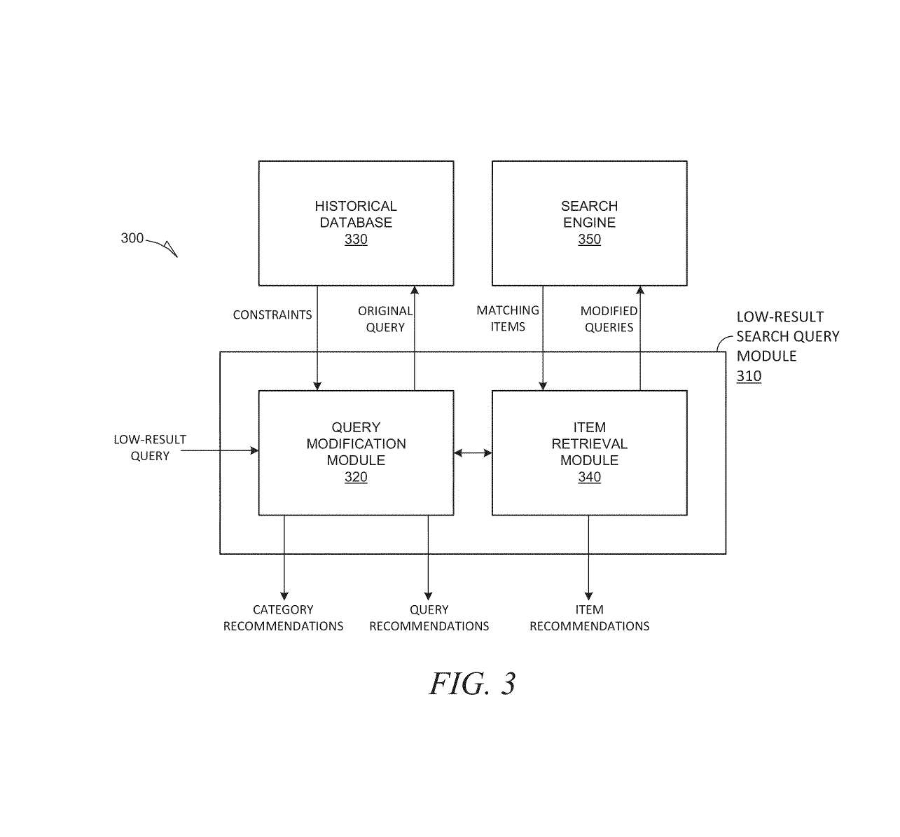

FIG. 3 is a block diagram illustrating an example embodiment of a system 300 that provides recommendations for low- and zero-result queries. System 300 comprises a low-result search query module 310 and a historical database 330. The historical database 330 stores historical data related to inactive expired or sold) e-commerce items. The historical data can include information about previous searches, such as queries and their related search results and clickstream data. The historical data can include category tree information and meta-data. The historical data can be based on the activity of multiple users or all users, not just restricted to information gathered from the activity of one particular user. The low-result search query module 310 is configured to receive a search query, access historical data in the historical database 330 using the search query, and generate one or more recommendations for the search query based on the accessed historical data. In some embodiments, the historical data is combined with other search intelligence features, such as understanding of the query, current inventory, and seller information, in order to generate the recommendations. In some embodiments, the historical data is accessed and the recommendations are generated when a search query run against a database of active inventory of e-commerce items yields a number of results less than a predefined low number of results (e.g., less than twenty-five results). In some embodiments, these functions can also be performed even without a search yielding a number of results less than a predefined low number of results.

In one example, a user enters “turquoise peace sign and cross” as her search query, but it is not initially matched to any available inventory. Therefore, low-result search query module 310 matches this query against a huge corpus of historical data of previously available, but currently unavailable, items in historical database 330. As mentioned above, the historical database 330 can include category tree information and meta-data regarding the previously available items. Based on the results of this historical data search, the user's intent can be inferred. For example, if the user's query matches some items that were sold two years ago in the jewelry category, it can be inferred that the user is looking for jewelry. These matched items that were sold two years ago could also be marked as having a color equal to turquoise. The low-result search query module 310 obtains these kind of signals regarding the user's intent and can infer that the user is looking for jewelry that is turquoise in color. Based on this knowledge, the low-result search query module 310 can provide the user with recommendations regarding her query. The recommendations can include item recommendations, category recommendations, and query recommendations. In some embodiments, the recommendations can include multiple forms of recommendations. For example, the recommendations can include any combination of item recommendations, category recommendations, and query recommendations.

Item recommendations are recommendations for available items that have been determined to be related to the user's original query. Item recommendations can be obtained by performing a search on a modified version of the user's original query. The modified version of the query can be produced by query modification module 320. In some embodiments, query modification module 320 accesses the historical data in the historical database 330 using the original query. As mentioned above, this historical data can include category tree information and meta-data. The query modification module 320 obtains constraints based on the historical data, and modifies the original query based on these constraints, thereby producing a modified query. This modified query can then be used by an item retrieval module 340 to search the site's available inventory using a search engine 350. If the modified query results in matching items from the site's available inventory, then these items can be presented to the user as item recommendations.

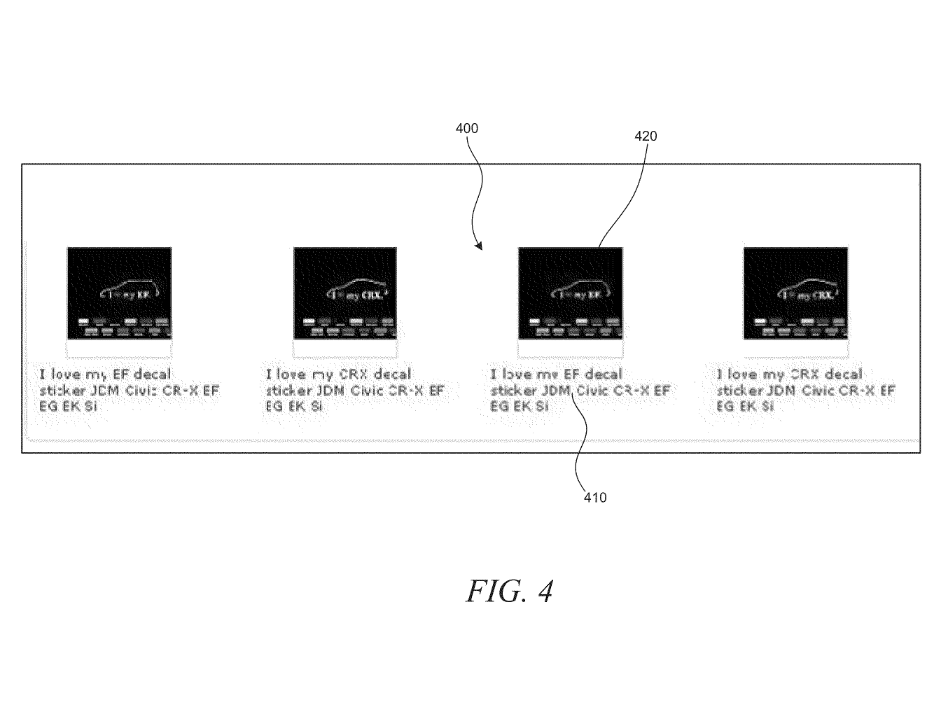

FIG. 4 illustrates an example embodiment of item recommendations 400 for a search query. In some embodiments, an item recommendation 400 comprises an item identifier 410, such as a name or title that can be used to identify the item. In some embodiments, the item recommendation 400 includes a graphical representation 420 of the available item to provide the user with an idea of what the item looks like. In the example provided in FIG. 4, the user has performed a search on the query “I love my ef sedan sticker” and is presented with four item recommendations 400.

Category recommendations are recommendations for categories that could be of interest to the user for browsing as they have been determined to be related to the user's original query. In the example of the input query “I love my ef sedan sticker” provided above for FIG. 4, the low-result search query module 310 could present the user with the following category recommendation:

Browse items in Collectibles→Transportation→Automobilia

Query recommendations are recommendations for queries that could be of interest to the user as they have been determined to be related to the user's original query. In the example of the input query “I love my ef sedan sticker” provided above for FIG. 4, the low-result search query module 310 could present the user with the following query recommendations:

Related Searches: i love my ef sticker sedan sticker
in Collectibles→Transportation→Automobilia
   In some embodiments, the query recommendations comprise suggested queries, as well as a preview of search results for each of the suggested queries. For example, using the “I love my ef sedan sticker” example above, in addition to the low-result search query module 310 presenting the user with the two recommended related searches “i love my ef sticker” and “sedan sticker,” it could also provide the user with a preview of the search results for those two related searches. Here, the user could see both a sampling of the results for a search on “i love my ef sticker” and a sampling of the results for a search on “sedan sticker” on the same page, thereby providing the user with more information on which path to take.

The recommendations provided by the low-result search query module 310 can be generated in a variety of ways. In some embodiments, the original query is passed into the query modification module 320 as input. The original query is then transformed by the query modification module 320. The transformed queries can then be used as query or category recommendations. In some embodiments, the transformed queries are of the form QᵢCⱼ indicating a search for keyword phrase Qᵢ in category Cⱼ. If Qᵢ is blank, then it is a pure category browse recommendation. Otherwise, it is a Related Searches/Query Suggestions recommendation. The transformed query can also be passed into the item retrieval module 340, which will retrieve recommended items. The item retrieval module 340 can run the transformed query against the search engine 350. The query can be run against different indexes, such as a title index, a description index, and a meta-data index. Any matching items can then be presented by the item retrieval module 340 to the user in the form of item recommendations.

The query modification module 320 analyzes the low-result queries for which the search engine 350 cannot find many matching items. For many such queries, the search engine 350 cannot find many matching items because the queries are over-constrained, specialized, or too verbose. In some embodiments, the query modification module 320 generalizes such queries. Generalization can be accomplished by dropping over-constraining terms from the original query (e.g., transforming “blue colored ipod nano” to “ipod nano”) or replacing terms in queries with more general terms (e.g., transforming ‘oak table” to “wood table”). Synonym, transliteration, and other mapping dictionaries can be used to modify the original query. In some embodiments, a prediction model can be used to drop terms from queries. The model tries to predict the necessity of terms in a query and recommends the least important term(s) (i.e., leads to the least amount of change in the meaning of the query) as the one(s) to drop. The model uses various features as input. Some of these features are behavioral features based on aggregated past user behavior. Other features are based on the e-commerce site's taxonomy tree and inventory corpus, such as titles and descriptions of items listed for sale. By looking at this information, the model can drop terms which other buyers have found to be less important, or terms which sellers deem to be less important based on their behavior.

The query modification module 320 and the item retrieval module 340 can communicate. This communication is useful, because if the transformed query cannot help in retrieving items to recommend, then it can be passed back to the query modification module 320 for further transformation. In some embodiments, this communication is based on a series of rules. One example of an execution based on a pre-configured rule is the following: Input Query Q (length x)→Query Modification Module (Q)→Transformed Query Q₁ (length x−1)/Category C₁→Item Retrieval Module (search Q₁C₁ against item titles)→No items found to recommend→Item Retrieval Module (search Q₁C₁ against item descriptions)→No items found to recommend→Query Modification Module (Q₁C₁)→Transformed Query Q₂ (length x−2)/Category C₁→Item Retrieval Module (search Q₂C₁ against item titles)→Found appropriate items to recommend. When queries are generalized by dropping terms, their length measured in terms of the number of terms in the query reduces.

In many cases, generalization can lead to loss of information or precision. Additionally, searching against longer contexts like descriptions instead of shorter titles can also lead to a loss of precision. In order to improve precision, the query modification module 320 can use metrics over the e-commerce site's taxonomy structure and add category constraints to the query. For example, the query “wow tcg loot card×51” might be generalized to “tcg loot card” and then a category constraint might be added to increase precision, consequently changing the query to “tcg loot card” in Toys & Hobbies>Trading Card Games>World of Warcraft. Category constraints can be found by looking at various sources, such as historical information and item-term-based category classifiers.

Items on e-commerce sites such as eBay are ephemeral and dynamic. A query might not be matched to any inventory today because all relevant inventory might have been sold. However, it is very likely that the query would have matched some inventory if it was run yesterday or a week or month before. The low-result search query module 310 leverages this fact to mine information on low-result queries. In some embodiments, a huge repository of historical site items is created. This repository could be on the order of 10 times larger than the current inventory available on the site. If the low-result query is matched against the historical database, the category structure information, seller and buyer information, item meta-data and other facts from history can then be used to annotate and enrich the low-result query. In some embodiments, category features can be added to the low-result query based on a K-Nearest Neighbor category classifier. The K-Nearest Neighbor algorithm could be trained based on terms found in previously-listed inventory stored in the historical database 330.

Examples of some low-result queries mapped to relevant categories using the historical database 330 are shown below.

| Tail Query | Category Recommendations |
|---|---|
| wow tcg loot | Toys & Hobbies > Trading Card Games > World of |
| card x 51 | Warcraft |
| clay tankards | Pottery & Glass > Pottery & China > Art Pottery > |
| | Other |
| storm trooper | Collectibles > Science Fiction & Horror > Star Wars > |
| face mask | Products, Non-Film Specific > Costumes, Masks |
| roebuck handbag | Clothing, Shoes & Accessories > Women's |
| | Accessories & Handbags > Handbags & Bags |
| bang olufsen | Electronics > Home Audio > Receivers, Electronics > |
| 7007 | Vintage Electronics > Books, Manuals & Magazines |

In some embodiments, the following algorithm can be used for query modification, using taxonomical feedback inferred from a database of expired items. The taxonomical feedback is used as a proxy for user intent when dealing with a low-result query. When the query is generalized, or otherwise relaxed, the taxonomical feedback helps maintain high fidelity to the user's intent. The input to the algorithm is a low-result query q, which is a query that returns few or zero items when searched over the current inventory of items. This query q is performed over items U₁, which is the set of all items that were active at any point since the last t time stamps. For example, U₆ₘₒₙₜₕₛ is the set of all items which were available at any point in the last 6 months. The query matches some of the expired items in U₁. Let's call this set of items Iₑ={iₑ₁, iₑ₂, iₑ₃, . . . , iₑₙ}. Each item iₑₖ belongs to the taxon in the taxonomy class. The algorithm can induce a probability distribution over taxonomy class C from Iₑ. The probability that the user wanted items from taxon l can be defined as a fraction of the items from taxon l that matched query q in the historical database. Some smoothing can be done for removing noise and edge cases. This distribution minors the user's intent for the query. The inferred distribution can then be used to infer key taxa that are most representative of the user's intent. Relaxation of the original query can then be performed by choosing a subset of queries having a decreased length from the original query. Subsets that are just one term smaller than the original query can be applied with the taxa constraints. These queries are searched with inferred taxa against the site's current inventory. Although relaxation of the original query may lead to decreased fidelity to the user's intent, constraining items to be found using relevant taxa helps boost the fidelity. These taxa reduce ambiguity from a relaxed query. As previously discussed, queries can also be constrained using meta-data, or other information related to an inactive item, that has been obtained from the historical database.

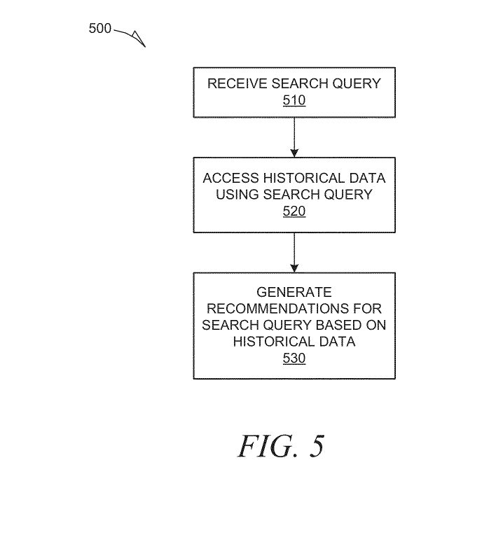

FIG. 5 is a flowchart illustrating an example embodiment of a method 500 for providing recommendations for low- and zero-result queries. At operation 510, a search query is received. At operation 520, historical data in a historical database is accessed using the search query. The historical data is related to inactive e-commerce items, such as sold or expired items. At operation 530, recommendations for the search query are generated based on the accessed historical data.

In some embodiments, the generated recommendations comprise item recommendations. In some embodiments, the search query is modified and a search is performed using the modified search query to generate the item recommendations. In some embodiments, the search query is modified using generalization techniques, as previously discussed. In some embodiments, the search query is modified using the historical data from the historical database. In some embodiments, the search query is modified by adding constraints. In some embodiments, the generated recommendations comprise category recommendations. In some embodiments, the recommendations comprise query recommendations. In some embodiments, the query recommendations comprise suggested queries and a preview of search results for each of the suggested queries.

In some embodiments, the steps of accessing the historical data and generating the recommendations are performed in response to a determination that the number of results for the search query is below a predetermined threshold. In some embodiments, the predetermined threshold is twenty-five, so that if a search query returns less than twenty-five, then it will trigger operation of the low-result search query module. However, it is contemplated that other threshold numbers can be used. In some embodiments, the historical data is accessed and the recommendations are generated even without the search query previously yielding a number of results below a certain threshold.

In some embodiments, the searching functions of the present embodiments are performed against the inventory of a single e-commerce site, as opposed to web-wide searches. Similarly, in some embodiments, the historical data in the historical database is related to previously-active, but currently-inactive, items of a single e-commerce site.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 104 of FIG. 1) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

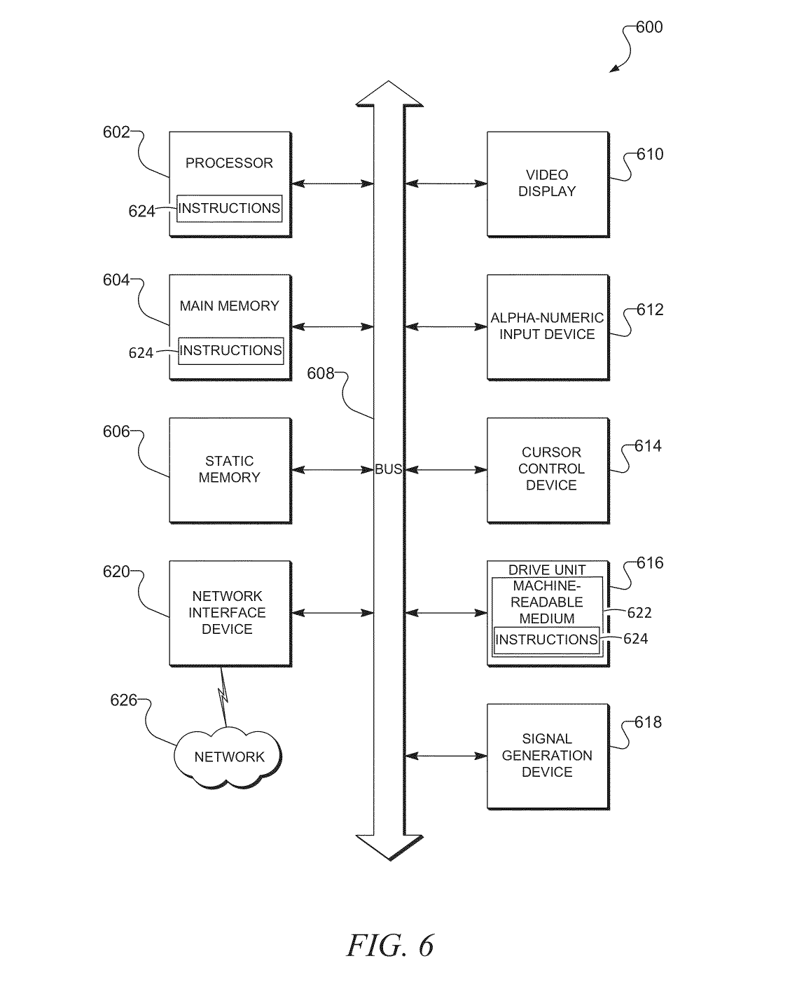

FIG. 6 is a block diagram of a machine in the example form of a computer system 600 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU) or both), a main memory 604 and a static memory 606, which communicate with each other via a bus 608. The computer system 600 may further include a video display unit 610 (e.g., a liquid crystal display (LCD) or a cathode ray tube (CRT)). The computer system 600 also includes an alphanumeric input device 612 (e.g., a keyboard), a user interface (UI) navigation (or cursor control) device 614 (e.g., a mouse), a disk drive unit 616, a signal generation device 618 (e.g., a speaker) and a network interface device 620.

### Machine-Readable Medium

The disk drive unit 616 includes a machine-readable medium 622 on which is stored one or more sets of data structures and instructions 624 (e.g., software) embodying or utilized by any one or more of the methodologies or functions described herein. The instructions 624 may also reside, completely or at least partially, within the main memory 604 and/or within the processor 602 during execution thereof by the computer system 600, the main memory 604 and the processor 602 also constituting machine-readable media. The instructions 624 may also reside, completely or at least partially, within the static memory 606.

While the machine-readable medium 622 is shown in an example embodiment to be a single medium, the term “machine-readable medium” may include a single medium or multiple media (e.g., a centralized or distributed database, and/or associated caches and servers) that store the one or more instructions 624 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

### Transmission Medium

The instructions 624 may further be transmitted or received over a communications network 626 using a transmission medium. The instructions 624 may be transmitted using the network interface device 620 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system comprising:
one or more processors;
a historical database storing historical data related to inactive e-commerce items; and
a low-result search query module, executable by the one or more processors, configured to:
receive a search query;
access historical data in the historical database using the search query; and
generate one or more recommendations for the search query based on the accessed historical data.

2. The system of claim 1, wherein the one or more recommendations comprises one or more item recommendations.

3. The system of claim 2, wherein the low-result search query module is further configured to:
modify the search query to produce a modified search query; and
perform a search using the modified search query to generate the one or more item recommendations.

4. The system of claim 1, wherein the one or more recommendations comprises one or more category recommendations.

5. The system of claim 1, wherein the one or more recommendations comprises one or more query recommendations.

6. The system of claim 5, wherein the one or more query recommendations comprise suggested queries and a preview of search results for each of the suggested queries.

7. The system of claim 1, wherein the low-result search query module is configured to access the historical data and generate the one or more recommendations in response to a determination that the number of results for the search query is below a predetermined threshold.

8. The system of claim 1, wherein the one or more recommendations comprise multiple forms of recommendations.

9. A computer-implemented method comprising:
receiving a search query,
accessing historical data in a historical database in a storage device using the search query, wherein the historical data is related to inactive e-commerce items; and
generating one or more recommendations for the search query based on the accessed historical data.

10. The method of claim 9, wherein the one or more recommendations comprises one or more item recommendations.

11. The method of claim 10, further comprising steps of:
modifying the search query to produce a modified search query; and
performing a search using the modified search query to generate the one or more item recommendations.

12. The method of claim 9, wherein the one or more recommendations comprises one or more category recommendations.

13. The method of claim 9, wherein the one or more recommendations comprises one or more query recommendations.

14. The method of claim 13, wherein the one or more query recommendations comprise suggested queries and a preview of search results for each of the suggested queries.

15. The method of claim 9, wherein the steps of accessing the historical data and generating the one or more recommendations are performed in response to a determination that the number of results for the search query is below a predetermined threshold.

16. The method of claim 9, wherein the one or snore recommendations comprise multiple forms of recommendations.

17. A non-transitory machine-readable storage device storing a set of instructions that, when executed by at least one processor, causes the at least one processor to perform operations comprising:
receiving a search query,
accessing historical data in a historical database using the search query, wherein the historical data is related to inactive e-commerce items; and
generating one or more recommendations for the search query based on the accessed historical data.

18. The device of claim 17, wherein the one or more recommendations comprises one or more item recommendations.

19. The device of claim 18, wherein the operations further comprise:
modifying the search query to produce a modified search query; and
performing a search using the modified search query to generate the one or more item recommendations.

20. The device of claim 17, wherein the one or more recommendations comprises one or more category recommendations.

21. The device of claim 17, wherein the one or more recommendations comprises one or more query recommendations.

22. The device of claim 21, wherein the one or more query recommendations comprise suggested queries and a preview of search results for each of the suggested queries.

23. The device of claim 17, wherein the steps of accessing the historical data and generating the one or more recommendations are performed in response to a determination that the number of results for the search query is below a predetermined threshold.
